(19) United States
(12) Patent Application Publication
(10) Pub. No.: US 2010/0302543 A1
(43) Pub. Date: Dec. 2, 2010

(54) METHOD OF MANUFACTURING OPTICAL RECEIVER MODULE AND APPARATUS FOR MANUFACTURING THE SAME

(75) Inventors: Yusuke Kurihara, Kanagawa (JP); Shigeru Moribayashi, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kawasaki-shi (JP)

(21) Appl. No.: 12/767,225

(22) Filed: Apr. 26, 2010

(30) Foreign Application Priority Data
May 29, 2009 (JP) 2009-130090

(51) Int. Cl. G01B 11/14

(52) U.S. Cl. 356/400

(57) ABSTRACT

The core adjusting process includes a procedure of searching for the position in which the photocurrent of the light-receiving element reaches its peak in each of the X-, Y-, and Z-directions. In the searching procedure, the light emitted from a multimode fiber of a MCP is gathered by a lens and is transmitted to the light-receiving element. A check is then made to determine whether, at in both directions of the search direction, there exist a first and second attenuation positions in which the photocurrent shows a predetermined attenuation relative to a peak value in a search range. If there exist the attenuation positions, a peak position is determined to be a position located within a second predetermined range from the middle point between the attenuation positions, and the relative positions of the receptacle and the CAN package are adjusted to the peak position.

This application is based on Japanese patent application No. 2009-130090, the content of which is incorporated herein by reference.

### BACKGROUND

1. Technical Field

The present invention relates to a method of manufacturing an optical receiver module and an apparatus for manufacturing an optical receiver module.

2. Related Art

First, the general structure of a semiconductor optical receiver module (an optical receiver module) including a planar light-receiving element (a photodiode (PD)) is described.

An optical receiver module including a planar light-receiving element includes a stem, a carrier placed on the stem, and a planar light-receiving element placed on the carrier. As well as the carrier and the light-receiving element, a trans-impedance amplifier (TIA), a capacitor for denoising, and the likes may be mounted on the stem. The optical receiver module further includes a cap (such as a flat-window cap having a flat window) that hermetically seals the above components placed on the stem, and a receptacle (with a built-in lens function, for example). By sealing the components on the stem with the cap, a CAN package is formed. The receptacle holds an optical fiber. The receptacle is fixed to the CAN package in the position in which the core of the optical fiber held in the receptacle is adjusted to the light-receiving element.

The core of the receptacle is adjusted to the light-receiving element of the cap-sealed CAN package through the procedures described below. In the following, the axis direction of the optical fiber is a Z-axis direction, one direction in a plane perpendicular to the axis direction (the plane being referred to as the X-Y plane) is an X-axis direction, and the direction perpendicular to the X-axis direction in the plane is a Y-axis direction.

While the light that is output from the end face of the optical fiber is being emitted onto the light-receiving element through the lens of the receptacle and the flat window of the cap, the position of the receptacle in the X-Y plane is adjusted. In this adjusting operation, the position of the receptacle is adjusted to a position in which the photocurrent becomes as large as possible in the X-Y plane. The position of the receptacle is then adjusted to a Z-axis direction position in which the photocurrent becomes as large as possible. After that, the position adjusting operation in the X-Y plane and the position adjusting operation in the Z-axis direction are repeated several times. As a result, the position of the receptacle approaches the position in which the photocurrent becomes largest. Accordingly, the receptacle is fixed to the CAN package in that position.

To fix the receptacle to the CAN package, it is important to place the receptacle to a location where the beam spot diameter in the light-receiving plane becomes as small as possible. This is because, in a planar light-receiving element, the photocurrent flows even when light is incident on a face slightly outside the PIN junction plane, but the field intensity in the face outside the PIN junction plane is lower than that in the PIN junction plane, resulting in degradation of the frequency characteristics of the light-receiving element. Even if the photocurrent is the same value at the time of core adjustment, the frequency characteristics of the light-receiving element are degraded when light is incident on a face outside the PIN junction plane of the light-receiving element. Therefore, when core adjustment is performed by moving the receptacle while the photocurrent is being monitored, the receptacle needs to be placed in the position in which the beam spot diameter becomes as small as possible.

Japanese Laid-open Patent Publication Nos. 8-18077 and 2006-295222 each disclose a method for manufacturing an optical receiver module by adjusting the core of the receptacle to the light-receiving element in the same manner as above.

To place a single-mode fiber in the Z-axis direction position that is the peak position of the photocurrent by either of the core adjustment techniques disclosed in Japanese Laid-open Patent Publication Nos. 8-18077 and 2006-295222, it is necessary to search a wide range for an appropriate Z-axis direction position. In the case of the technique disclosed in Japanese Laid-open Patent Publication No. 8-18077 (see FIG. 3), the Z-axis direction position in which the photocurrent becomes largest has a range of approximately 600 μm. Therefore, an appropriate Z-axis direction position needs to be detected from such a wide range. As a result, a long period of time is required for performing the core adjusting operation in the optical receiver module manufacturing process.

Due to the above circumstances, it is difficult to perform the core adjustment in a short period of time in the manufacture of an optical receiver module including a planar PIN-PD.

### SUMMARY

According to the present invention, there is provided a method for manufacturing an optical receiver module that includes a receptacle to which an optical connector holding an optical fiber is inserted, a lens that gathers light emitted from the optical fiber, and a CAN package including a planar PIN-PD as a light-receiving element that receives the light gathered by the lens. This method includes: adjusting relative positions of the receptacle and the CAN package including: determining a peak position in which a photocurrent reaches a peak value in a predetermined adjustment direction, while light is emitted from the optical fiber to the light-receiving element through the lens; and adjusting the relative positions to the peak position; and fixing the receptacle and the CAN package to each other in a position adjusted through the adjusting the relative positions, the adjusting the relative positions including: a first procedure to determine the peak position, while the adjustment direction is set to one direction in a plane perpendicular to a core direction of the optical fiber, and adjusting the relative positions to the peak position; and a second procedure to determine the peak position, while the adjustment direction is set to a direction perpendicular to the one direction in the plane, and adjusting the relative positions to the peak position; and a third procedure to determine the peak position, while the adjustment direction is set to the core direction, and adjusting the relative positions to the peak position; and at least one of the first through third procedures being carried out by performing a specific core adjusting process, the specific core adjusting process including: detecting the photocurrent, while moving the receptacle and the CAN package relative to each other in the adjustment direction within a first predetermined range, while using a multimode fiber of a MCP (Mode Conditioning Patch cord) or using a multimode fiber connected to the MCP as the optical fiber; and determining whether, there exist a first attenuation position and a second attenuation position in which the photocurrent shows a predetermined attenuation compared with the peak value within the first predetermined range, at in both directions of the adjustment direction from an interim peak position in which the photocurrent reaches the peak value within the first predetermined range; when there exist the first attenuation position and the second attenuation position, determining the peak position that is an arbitrary position located between the first attenuation position and the second attenuation position, and is located within a second predetermined range from a middle point between the first attenuation position and the second attenuation position.

By this manufacturing method, the light emitted from the multimode fiber of a MCP, or the light emitted from a multimode fiber connected to a MCP, is gathered by the lens, and the light-receiving element receives the light gathered by the lens. With this arrangement, the light in the light-receiving face of the light-receiving element can spread more widely than in a case where a lens gathers light emitted from a single mode fiber, and a light-receiving element receives the light gathered by the lens. Accordingly, each of the tolerance curves in the one direction in the plane perpendicular to the core direction, the direction perpendicular to the one direction, and the core direction can be made steeper than in the case where a lens gathers the light emitted from a single mode fiber, and a light-receiving element receives the light gathered by the lens. As a result of this, the first predetermined range in which the receptacle and the CAN package are moved relative to each other to achieve the desired attenuation can be made narrower than in the case where a lens gathers the light emitted from a single mode fiber, and a light-receiving element receives the light gathered by the lens. Accordingly, the core adjustment can be performed in a shorter period of time, and the time required for manufacturing the optical receiver module can be shortened. Since the tolerance curve in each direction can be made steeper than in the case where a lens gathers the light emitted from a single mode fiber, and a light-receiving element receives the light gathered by the lens, the value of the desired attenuation can be set at a greater value. Accordingly, false detection of a peak position due to an adverse influence of noise can be prevented. Furthermore, since the tolerance curve in each direction can be made steeper, the peak position can be detected with high precision, and the yield rate in the frequency response characteristics of the optical receiver module can be improved.

In another embodiment, there is provided an apparatus for manufacturing an optical receiver module that includes a receptacle to which an optical connector holding an optical fiber is inserted, a lens that gathers the light emitted from the optical fiber, and a CAN package including a planar PIN-PD as a light-receiving element that receives the light gathered by the lens. This apparatus includes: a first holding unit that holds the receptacle; a second holding unit that holds the CAN package; a relative position adjustment unit that adjusts the relative positions of the receptacle and the CAN package by moving the first holding unit and the second holding unit relative to each other; a photocurrent detection unit that detects a photocurrent; and a control unit that performs a control operation including operation control of the relative position adjustment unit, and a calculating operation based on the photocurrent detected by the photocurrent detection unit. The control unit carries out: adjusting relative positions of the receptacle and the CAN package including: determining a peak position in which a photocurrent reaches a peak value in a predetermined adjustment direction, while light is emitted from the optical fiber to the light-receiving element through the lens; and adjusting the relative positions to the peak position; and fixing the receptacle and the CAN package to each other in a position adjusted through the adjusting the relative positions, the adjusting the relative positions including: a first procedure to determine the peak position, while the adjustment direction is set to one direction in a plane perpendicular to a core direction of the optical fiber, and adjusting the relative positions to the peak position; and a second procedure to determine the peak position, while the adjustment direction is set to a direction perpendicular to the one direction in the plane, and adjusting the relative positions to the peak position; and a third procedure to determine the peak position, while the adjustment direction is set to the core direction, and adjusting the relative positions to the peak position; and at least one of the first through third procedures being carried out by performing a specific core adjusting process, the specific core adjusting process including: detecting the photocurrent, while moving the receptacle and the CAN package relative to each other in the adjustment direction within a first predetermined range, while using a multimode fiber of a MCP (Mode Conditioning Patch cord) or using a multimode fiber connected to the MCP as the optical fiber; and determining whether, there exist a first attenuation position and a second attenuation position in which the photocurrent shows a predetermined attenuation compared with the peak value within the first predetermined range, at in both directions of the adjustment direction from an interim peak position in which the photocurrent reaches the peak value within the first predetermined range; when there exist the first attenuation position and the second attenuation position, determining the peak position that is an arbitrary position located between the first attenuation position and the second attenuation position, and is located within a second predetermined range from a middle point between the first attenuation position and the second attenuation position.

According to the present invention, the core adjustment can be performed in a short period of time in the manufacture of an optical receiver module that includes a planar PIN-PD, and the relative position of the receptacle relative to the CAN package can be searched for with high precision, so that desired characteristics can be achieved.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a cross-sectional view showing the structure of an optical receiver module manufactured by a method for manufacturing an optical receiver module according to a first embodiment;

FIG. 2 is a cross-sectional view showing a situation where an optical connector is inserted to the optical receiver module of FIG. 1;

FIG. 3 is a flowchart showing the method for manufacturing an optical receiver module according to the first embodiment;

FIG. 4 shows the light intensity distribution in the end face of an optical fiber;

FIG. 5 shows the photocurrent that varies with the position of the receptacle in the X-axis direction;

FIG. 6 shows the photocurrent that varies with the position of the receptacle in the Z-axis direction;

FIG. 7 is a block diagram showing the structure of an apparatus for manufacturing an optical receiver module according to the first embodiment;

FIG. 8 is a flowchart showing a method for manufacturing an optical receiver module according to a first modification;

FIG. 9 is a flowchart showing a method for manufacturing an optical receiver module according to a second modification;

FIG. 10 is a flowchart showing a method for manufacturing an optical receiver module according to a third modification;

FIG. 11 is a flowchart showing a method for manufacturing an optical receiver module according to a fourth modification;

FIG. 12 is across-sectional view showing the structure of an optical receiver module manufactured by a method for manufacturing a optical receiver module according to a second embodiment;

FIG. 13 is across-sectional view showing the structure of an planar PIN-PD; and

FIG. 14 shows the relationship between the photocurrent and the in-band deviation degradation, which depends on the position of the receptacle in the X-axis direction.

### DETAILED DESCRIPTION

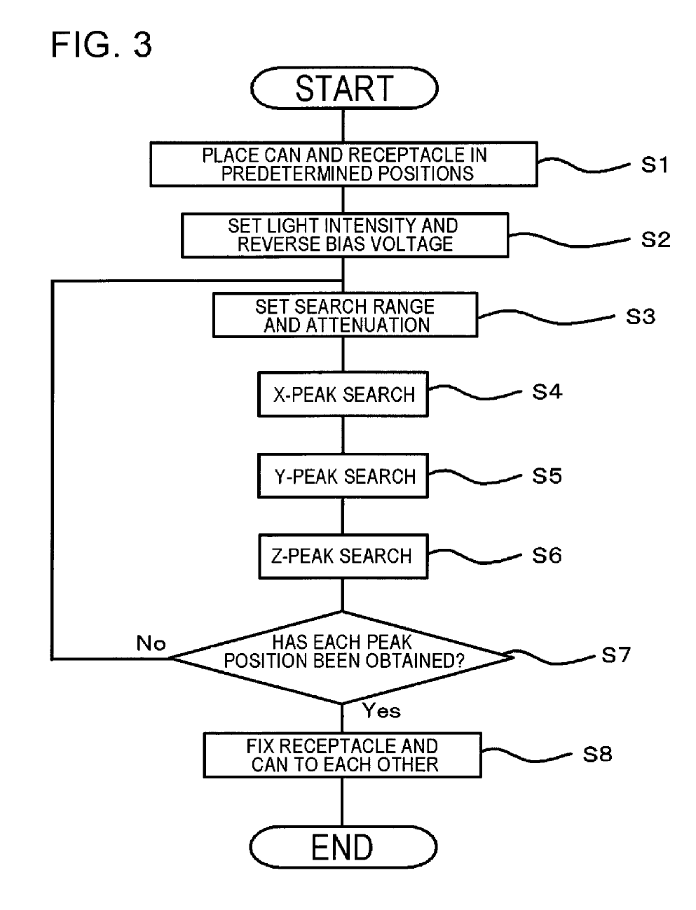

As described above, to determine the position in the Z-axis direction of a single-mode fiber that is a peak position of a photocurrent by the core adjusting methods disclosed in Japanese Laid-open Patent Publication Nos. 8-18077 and 2006-295222, it is necessary to search a wide range for an appropriate Z-axis direction position. By the technique disclosed in Japanese Laid-open Patent Publication No. 8-18077, the range of the Z-axis direction position in which the photocurrent becomes largest has a width of approximately 600 μm, for example. Therefore, it is necessary to search Z-axis direction positions in a wide range for an appropriate Z-axis direction position, as shown in FIG. 3. As a result, a long period of time is required for the core adjusting operation in the process for manufacturing an optical receiver module. Further, since the search range is wide, there is a higher possibility that the components interfere with each other (collide with each other), and core adjustment cannot be performed, when a core adjusting operation is performed in a direction in which the optical fiber and the light-receiving element come close to each other.

The reasons that the photocurrent has its largest value in a wide range as described above include that the beam spot diameter (20 μm, for example) of light on the light-receiving face of the light-receiving element is sufficiently smaller than the light-receiving diameter (80 μm, for example) of the light-receiving element.

In Japanese Laid-open Patent Publication No. 8-18077, the structure of the light-receiving element is not particularly specified. However, in the case of a planar PIN-PD, it is more difficult to detect a peak position, since the Z-tolerance curve of the photocurrent is gentler than in the case of a mesa PIN-PD. The reasons for this are described in the following.

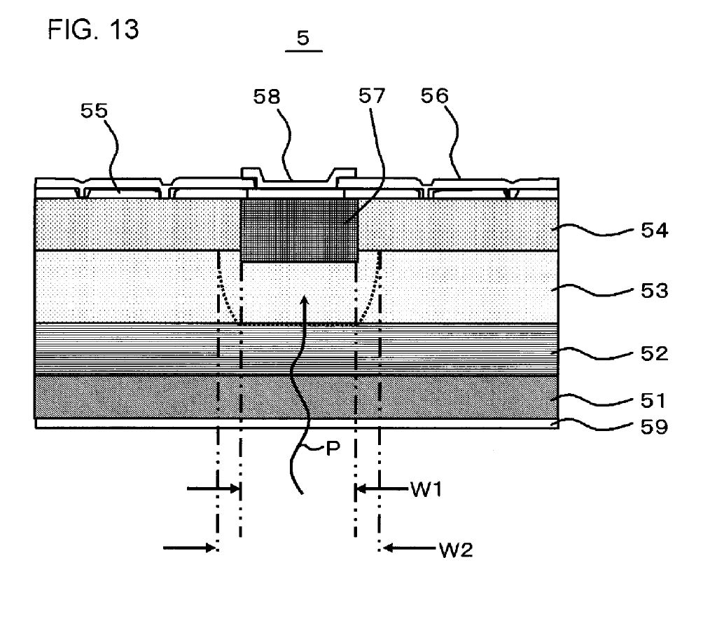

FIG. 13 is across-sectional view showing the structure of a planar PIN-PD. As shown in FIG. 13, the planar light-receiving element 5 includes an InP substrate 51, an n-type InP layer 52 formed on the InP substrate 51, an n⁻-type InGaAs layer 53 formed on the n-type InP layer 52, an n-type InP layer 54 formed on the n⁻-type InGaAs layer 53, an n-electrode 55 formed on the n-type InP layer 54, and a passivation film 56 formed on the n-electrode 55. A Zn diffusion region 57 is formed in the n-type InP layer 54, and a p-electrode 58 is formed on the Zn diffusion region 57. Another passivation film 59 is formed under the bottom face of the InP substrate 51.

In the case of a planar light-receiving element having the above structure, it is necessary to have light P incident on a range of a diffusion diameter W1. This is because, when a reverse bias (a reverse bias voltage) is applied to the light-receiving element, a depletion layer spreads not only in the vertical direction but also in the horizontal direction in FIG. 13 (see the depletion layer diameter W2 of FIG. 13), and the light-absorbing region becomes larger than the diffusion diameter W1. Since the field intensity in the region depleted in the horizontal direction becomes smaller than the field intensity at the center, sufficient field intensity is not applied to photo carriers generated by coupling light to this region. Therefore, the carrier drift velocity is low, and the frequency characteristics of photoelectric conversion are degraded.

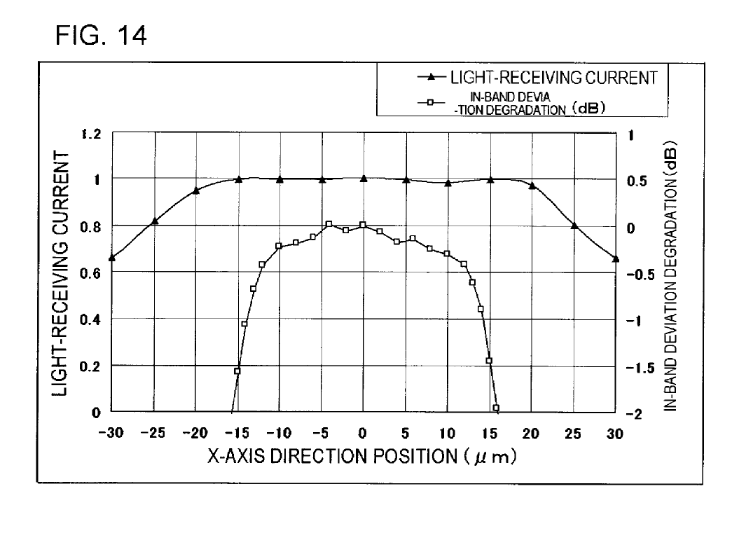

FIG. 14 shows the results of measurement of the photocurrent and the in-band deviation degradation while the position of light incident on the light-receiving face of a planar light-receiving element having the diffusion diameter W1 of 30 μm, for example. Here, the in-band deviation degradation is defined. The difference between the photoelectric conversion gain at 100 MHz and the photoelectric conversion gain at 7 GHz where the X-axis direction position is an arbitrary position is a “first difference”. The difference between the photoelectric conversion gain at 100 MHz and the photoelectric conversion gain at 7 GHz where the X-axis direction position is 0 μm is a “second difference”. The in-band deviation degradation is defined as the difference between the “first difference” and the “second difference”. When the frequency characteristics of photoelectric conversions are degraded, the numerical value of the in-band deviation degradation becomes smaller. According to the measurement results shown in FIG. 14, the decrease of the in-band deviation degradation exceeds 0.5 dB in each of the region where the X-axis direction position is less than −12 μm and the region where the X-axis direction position is more than 12 μm. Meanwhile, the decrease of the photocurrent exceeds 5% in each of the region where the X-axis direction position is less than −20 μm and the region where the X-axis direction position is more than 20 μm. In other words, the X-tolerance of the frequency characteristics is narrower than the X-tolerance of the photocurrent. Therefore, it is necessary to adjust the core of the receptacle in a position that exhibits excellent frequency characteristics, and it is essential to perform coupling in the peak position with precision.

As described above, it is difficult to perform core adjustment in a short period of time when an optical receiver module including a planar PIN-PD is manufactured.

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the present invention will be explained below, referring to the attached drawings. Note that any similar constituents will be given the same reference numerals or symbols in all drawings, and explanations therefor will not be repeated.

### First Embodiment

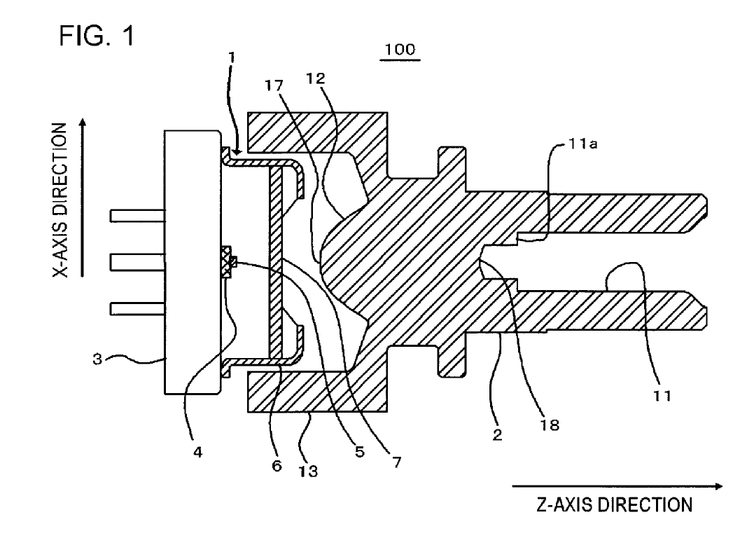

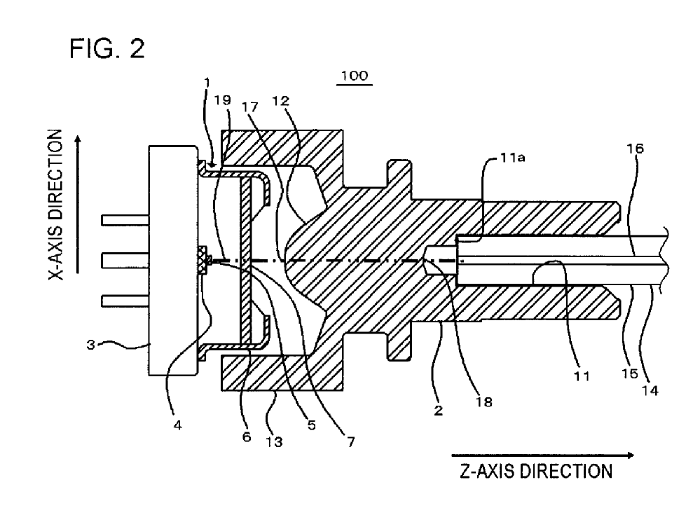

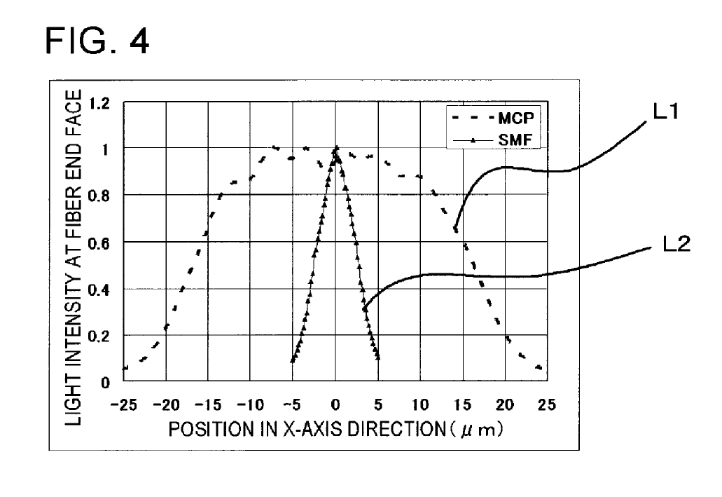

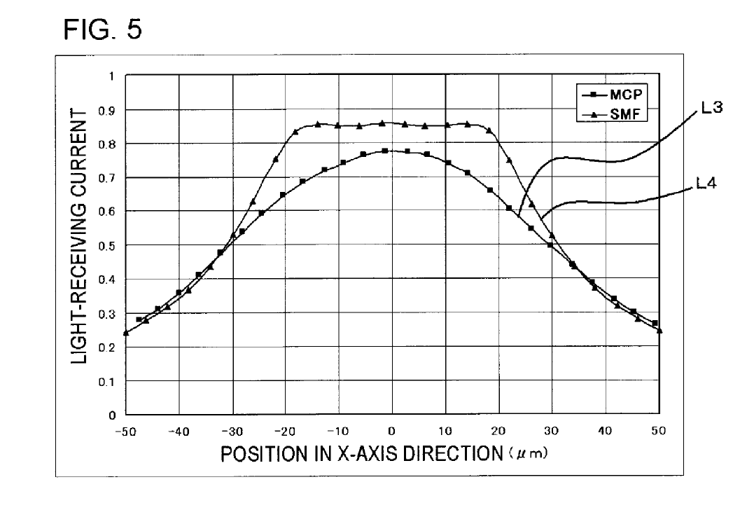

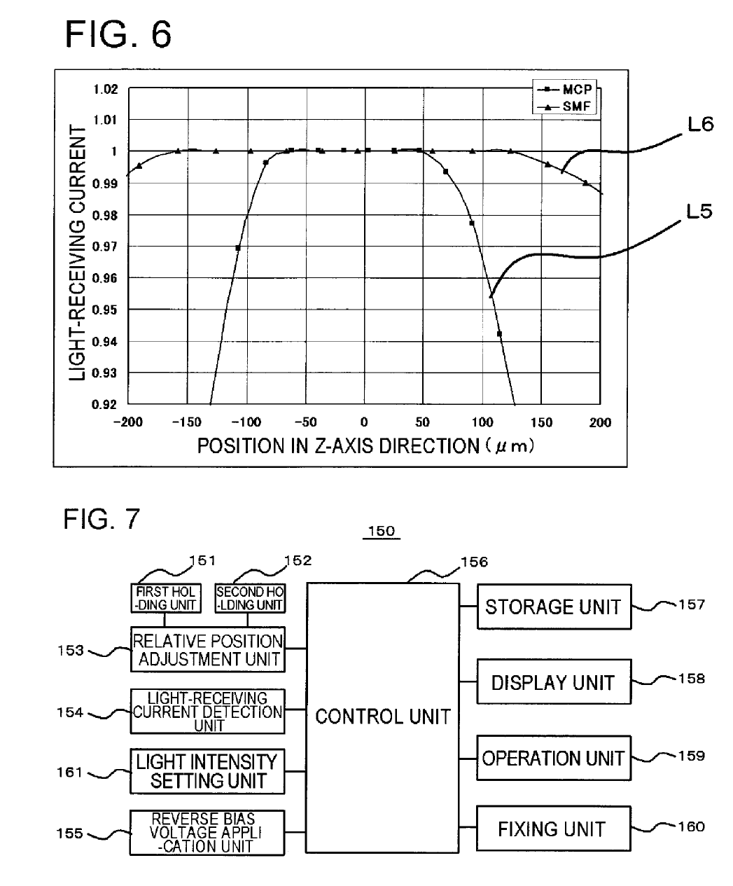

FIG. 1 is a cross-sectional view showing the structure of an optical receiver module 100 that is manufactured by a method for manufacturing an optical receiver module according to a first embodiment. FIG. 2 is a cross-sectional view showing a situation where an optical connector 14 is inserted to the optical receiver module 100 of FIG. 1. FIG. 3 is a flowchart showing the method for manufacturing an optical receiver module according to the first embodiment. FIG. 4 shows the light intensity distribution in the end face of the optical fiber connected to a receptacle 2. FIG. 5 shows the photocurrent varying with the position of the receptacle 2 in the X-axis direction. FIG. 6 shows the photocurrent varying with the position of the receptacle 2 in the Z-axis direction. FIG. 7 is a block diagram showing the structure of an optical receiver module manufacturing apparatus 150 according to the first embodiment.

The method for manufacturing an optical receiver module includes a receptacle 2 to which an optical connector 14 holding an optical fiber 16 is inserted, a lens 12 that gathers light emitted from the optical fiber 16, and a CAN package 1 that includes a planar PIN-PD as a light-receiving element 5 that receives the light gathered by the lens 12. This method includes: a core adjusting process (steps S1 through S7 of FIG. 3, for example) to adjust the relative positions of the receptacle 2 and the CAN package 1 including: determining a peak position in which a photocurrent reaches a peak value in a predetermined adjustment direction, while light is emitted from the optical fiber 16 to the light-receiving element 5 through the lens 12; and adjusting the relative positions; and a fixing process (step S8 of FIG. 3) to fix the receptacle 2 and the CAN package 1 to each other in the positions adjusted through the core adjusting process. The core adjusting process includes: a first procedure to determine the peak position, while the adjustment direction is set to one direction (the X-axis direction) in a plane perpendicular to a core direction (the Z-axis direction) of the optical fiber 16, and adjusting the relative positions to the peak position; and a second procedure to determine the peak position, while the adjustment direction is set to a direction (the Y-axis direction) perpendicular to the one direction in the plane, and adjusting the relative positions to the peak position; and a third procedure to determine the peak position, while the adjustment direction is set to the core direction (the Z-axis direction), and adjusting the relative positions to the peak position. At least one of the first through third procedures is carried out by performing a specific core adjusting process. The specific core adjusting process includes: detecting the photocurrent, while moving the receptacle 2 and the CAN package 1 relative to each other in the adjustment direction within a first predetermined range, while using a multimode fiber of a MCP (Mode Conditioning Patch cord) or using a multimode fiber connected to the MCP as the optical fiber 16; determining whether, there exist a first attenuation position and a second attenuation position in which the photocurrent shows a predetermined attenuation compared with the peak value within the first predetermined range, at in both directions of the adjustment direction from an interim peak position in which the photocurrent reaches the peak value within the first predetermined range; when there exist the first attenuation position and the second attenuation position, determining the peak position that is an arbitrary position located between the first attenuation position and the second attenuation position, and is located within a second predetermined range from a middle point between the first attenuation position and the second attenuation position.

The apparatus (apparatus 150) for manufacturing an optical receiver module includes a receptacle 2 to which an optical connector 14 holding an optical fiber 16 is inserted, a lens 12 that gathers the light emitted from the optical fiber 16, and a CAN package 1 that includes a planar PIN-PD as a light-receiving element 5 that receives the light gathered by the lens 12. This apparatus includes: a first holding unit 151 that holds the receptacle 2; a second holding unit 152 that holds the CAN package 1; a relative position adjustment unit 153 that adjusts the relative positions of the receptacle 2 and the CAN package 1 by moving the first holding unit 151 and the second holding unit 152 relative to each other; a photocurrent detection unit 154 that detects a photocurrent; and a control unit 156 that performs a control operation including operation control of the relative position adjustment unit 153, and a calculating operation based on the photocurrent detected by the photocurrent detection unit 154. The control unit 156 carries out: a core adjusting process (steps S1 through S7 of FIG. 3, for example) to adjust the relative positions of the receptacle 2 and the CAN package 1 including: determining a peak position in which a photocurrent reaches a peak value in a predetermined adjustment direction, while light is emitted from the optical fiber 16 to the light-receiving element 5 through the lens 12; and adjusting the relative positions; and a fixing process (step S8 of FIG. 3) to fix the receptacle 2 and the CAN package 1 to each other in the positions adjusted through the core adjusting process. The core adjusting process includes: a first procedure to determine the peak position, while the adjustment direction is set to one direction (the X-axis direction) in a plane perpendicular to a core direction (the Z-axis direction) of the optical fiber 16, and adjusting the relative positions to the peak position; and a second procedure to determine the peak position, while the adjustment direction is set to a direction (the Y-axis direction) perpendicular to the one direction in the plane, and adjusting the relative positions to the peak position; and a third procedure to determine the peak position, while the adjustment direction is set to the core direction (the Z-axis direction), and adjusting the relative positions to the peak position. At least one of the first through third procedures is carried out by performing a specific core adjusting process. The specific core adjusting process includes: detecting the photocurrent, while moving the receptacle 2 and the CAN package 1 relative to each other in the adjustment direction within a first predetermined range, while using a multimode fiber of a MCP (Mode Conditioning Patch cord) or using a multimode fiber connected to the MCP as the optical fiber 16; determining whether, there exist a first attenuation position and a second attenuation position in which the photocurrent shows a predetermined attenuation compared with the peak value within the first predetermined range, at in both directions of the adjustment direction from an interim peak position in which the photocurrent reaches the peak value within the first predetermined range; when there exist the first attenuation position and the second attenuation position, determining the peak position that is an arbitrary position located between the first attenuation position and the second attenuation position, and is located within a second predetermined range from a middle point between the first attenuation position and the second attenuation position.

In the following, the method and the apparatus are described in detail.

First, the structure of the optical receiver module 100 is described.

As shown in FIG. 1, the optical receiver module 100 manufactured by the method for manufacturing an optical receiver module according to this embodiment includes a CAN package (hereinafter referred to simply as CAN) 1 and a receptacle 2 with a built-in lens.

The CAN 1 includes a stem 3, a carrier 4, a light-receiving element (PD: PhotoDiode) 5, and a cap 6, for example.

The carrier 4 is fixed on the stem 3. The carrier 4 is an insulating substrate on which the light-receiving element 5 is mounted. A metalizing pattern (not shown) for taking out signals from the electrode of the light-receiving element 5 is formed on the carrier 4. Depending on the structure of the electrode of the light-receiving element 5, this metalizing pattern might become unnecessary.

The light-receiving element 5 is fixed on the carrier 4. The light-receiving element 5 is a planar PIN-PD of a back illuminated type. The light-receiving element 5 has the structure shown in FIG. 13.

As well as the carrier 4 and the light-receiving element 5, a trans-impedance amplifier (TIA) (not shown) and a capacitor for denoising (not shown) may be mounted on the stem 3.

Those components (such as the carrier 4 and the light-receiving element 5) placed on the stem 3 are hermetically sealed with the cap 6. The cap 6 is a flat-window cap having a flat window 7, for example. By sealing the components on the stem 3 with the cap 6 in this manner, the CAN 1 is formed.

The receptacle 2 includes an optical connector insertion portion 11, a lens 12, and a cylindrical fixing portion 13. In this embodiment, the receptacle 2 does not include a SMF (Single-Mode Fiber) stub.

The lens 12 gathers light emitted from an optical fiber 16, and releases the light onto the light-receiving element 5. The lens 12 includes a convex face 17 located on the side of the light-receiving element 5, and a concave face 18 located on the side of the optical connector insertion portion 11, for example. The positional relationship between the convex face 17 and the concave face 18 of the lens 12 determines the relationship between the optical axis 19 of the light released from the lens 12 and the core direction of the optical fiber 16, or whether the optical axis 19 matches the core direction or whether the optical axis 19 deviates from the core direction.

The optical connector insertion portion 11 is designed to have a cylindrical joint-like structure, and the optical connector 14 (see FIG. 2) can be inserted into the optical connector insertion portion 11. As shown in FIG. 2, the optical connector 14 includes a ferrule 15, and the optical fiber 16 is placed in the ferrule 15. A step portion 11a is formed in the optical connector insertion portion 11. The deeper side (the side of the lens 12) than the step portion 11a of the optical connector insertion portion 11 has the smaller diameter, and the side nearer the opening end of the optical connector insertion portion 11 than the step portion 11a has the larger diameter. The front end of the optical connector 14 is stopped by the step portion 11a, and the optical connector 14 is positioned in the optical connector insertion portion 11.

In this manner, the receptacle 2 holds the optical fiber 16. The receptacle 2 is fixed to the CAN 1, at a location where the core of the optical fiber 16 held in the receptacle 2 is adjusted to the light-receiving element 5. The CAN 1 is fixed to the inner circumference of the cylindrical fixing portion 13 through adhesion with an adhesive agent (not shown), for example.

The optical fiber 16 may be a multimode fiber having a MCP (Mode Conditioning Patch cord) (only partially shown), or a multimode fiber (MMF) connected (added) to the multimode fiber of a MCP. A MCP is a patch cord that has a SMF at the light input end, and has a MMF at the light output end.

Next, the method for manufacturing the optical receiver module according to this embodiment is described.

As shown in FIG. 3, by the method for manufacturing an optical receiver module according to this embodiment, steps S1 through S7 are carried out as the core adjusting process to adjust the relative positions of the receptacle 2 and the CAN 1, and step S8 is carried out as a fixing process to fix the receptacle 2 and the CAN 1 to each other in the position set through the core adjusting process.

The core adjusting process includes: a first procedure (step S4), a second procedure (step S5), and a third procedure (step S6) to determine the position in which the photocurrent reaches its peak in an adjustment direction, while light is emitted from the optical fiber 16 to the light-receiving element 5 through the lens 12; in the first procedure, the adjustment direction is one direction (the X-axis direction) in a plane (also referred to as the X-Y plane) perpendicular to the core direction (the Z-axis direction) of the optical fiber 16, in the second procedure, the adjustment direction (the Y-axis direction) is perpendicular to the above direction in the X-Y plane, in the third procedure, the adjustment direction is the core direction (the Z-axis direction) of the optical fiber 16. The X-axis direction and the Z-axis direction are the directions shown in FIGS. 1 and 2, and the Y-axis direction is the direction from the front side to the back side in each of the drawings of FIGS. 1 and 2.

In this embodiment, the first through third procedures are carried out through a specific core adjusting process. More specifically, in the first through third procedures, the photocurrent is detected while the receptacle 2 and the CAN 1 are being moved in the respective adjustment directions in a relative manner within a first predetermined range. A check is then made to determine whether there exist a first attenuation position and a second attenuation position in which the photocurrent shows a predetermined attenuation compared with a peak value within the first predetermined range, at in both directions of the adjustment direction from an interim peak position in which the photocurrent reaches the peak value within the first predetermined range. If there exist the first attenuation position and the second attenuation position, the peak position is determined to be the position that lies between the first attenuation position and the second attenuation position, and is located within a second predetermined range from the middle point between the first and second attenuation positions, and the relative positions of the receptacle 2 and the CAN 1 in the adjustment direction are adjusted to the peak position.

If at least one of the first and second attenuation positions is determined not to exist in at least one of the first through third procedures, a fourth procedure (step S3) is carried out to make at least one of the following setting changes: a first setting change to enlarge the first predetermined range (a search range), and a second setting change to reduce the predetermined attenuations. After the fourth procedure, the first through third procedures are again carried out.

In this embodiment, a fifth procedure is carried out to perform the first through third procedures in arbitrary order, without the fourth procedure. If a peak position cannot be detected because at least one of the first and second attenuation positions is determined not to exist in at least one of the first through third procedures of the fifth procedure, the fifth procedure is again carried out after the fourth procedure is carried out.

This method is described below in greater detail.

First, at step S1, the CAN 1 and the receptacle 2 are placed at predetermined positions. For example, the position of the receptacle 2 at this point is set as the initial position.

At step S2, the intensity of the light to be emitted from the optical fiber 16, and the reverse bias voltage to be applied to the light-receiving element 5 are set.

At step S3, value of “a” and “b” are set. Value of “a” is a half value of the search-range, and value of “b” is a predetermined attenuation. The search range may be a range of “a” (μm) in the positive direction from the above initial position, and “a” (μm) in the negative position from the above initial position, for example. Therefore, setting the value of “a” is to set the search range. Here, the value of “a” may be the value common among the X-peak search, the Y-peak search, and the Z-peak search, or may be a unique value for each of the searches. The same applies to the value of “b”. In the following, “a” and “b” are both used as individual values for each of the X-, Y-, and Z-peak searches, for example. However, the initial values of “a” and “b” (the values that are set in the first execution of step S3) are common values between the X-peak search and the Y-peak search. More specifically, in the first execution of step S3, the value of “a” in the X-peak search and the Y-peak search is set at 30 (μm), the value of “a” in the Z-peak search is set at 100 (μm), the value of “b” in the X-peak search and the Y-peak search is set at 10(%), and the value of “b” in the Z-peak search is set at 5(%).

At step S4, the X-peak search is performed. More specifically, a search is made for a peak position in the X-axis direction. In this operation, the photocurrent generated by the light-receiving element 5 is detected, while the receptacle 2 is moved relative to the CAN 1 within the range (the first predetermined range) of “a” (μm) in the positive direction from the above initial position in the X-axis direction and “a” (μm) in the negative direction. The value of “a” used here is the value of “a” for the X-peak search. For example, the detection of the photocurrent is performed at a predetermined pitch (a 1-μm pitch, for example). The peak value of the photocurrent detected within the first predetermined range is then measured. Such a position in the X-axis direction that the photocurrent becomes to this peak value is determined as an interim peak position. An attenuation position where the photocurrent shows a predetermined attenuation with respect to the peak value is then measured in each of the positive and negative directions in the X-axis direction from the interim peak position. More specifically, attenuation positions where the photocurrent attenuates by “b” (%) with respect to the peak value are measured. The value of “b” used here is the value of “b” for the X-peak search. The attenuation position in the positive direction from the interim peak position is referred to as the first attenuation position, and the attenuation position in the negative direction from the interim peak position is referred to as the second attenuation position. The position that is between the first and second attenuation positions and is located within a second predetermined range from the middle point between the first and second attenuation positions is determined as the peak position (the X-peak position) in the X-axis direction. The position of the receptacle 2 in the X-axis direction is then adjusted to the X-peak position.

In the X-peak search, an attenuation position where the photocurrent attenuates by “b” (%) with respect to the peak value might not exist within the search range, depending on the search conditions. Therefore, in some cases, at least one of the first and second attenuation positions cannot be measured, the peak position (the X-peak position) cannot be determined, and the position of the receptacle 2 cannot be adjusted to the X-peak position. In such cases, the position of the receptacle 2 in the X-axis direction is adjusted to the interim peak position in the X-axis direction.

At step S5, the Y-peak search is performed in the same manner as the X-peak search. In this operation, the photocurrent is detected, while the receptacle 2 is moved relative to the CAN 1 within the range (the first predetermined range) of “a” (μm) in the positive direction from the above initial position in the Y-axis direction and “a” (μm) in the negative direction. The value of “a” used here is the value of “a” for the Y-peak search. For example, the detection of the photocurrent is performed at a predetermined pitch (a 1-μm pitch, for example). The peak value of the photocurrent detected within the first predetermined range is then measured. Such a position in the Y-axis direction that the photocurrent becomes to this peak value is determined as an interim peak position. An attenuation position where the photocurrent shows a predetermined attenuation with respect to the peak value is then measured in each of the positive and negative directions in the Y-axis direction from the interim peak position. More specifically, attenuation positions where the photocurrent attenuates by “b” (%) with respect to the peak value are measured. The value of “b” used here is the value of “b” for the Y-peak search. The attenuation position in the positive direction from the interim peak position is referred to as the first attenuation position, and the attenuation position in the negative direction from the interim peak position is referred to as the second attenuation position. The position that is between the first and second attenuation positions and is located within a second predetermined range from the middle point between the first and second attenuation positions is determined as the peak position (the Y-peak position) in the Y-axis direction. The position of the receptacle 2 in the Y-axis direction is then adjusted to the Y-peak position.

In the Y-peak search, depending on the search conditions, at least one of the first and second attenuation positions might not be measured, the peak position (the Y-peak position) might not be determined, and the position of the receptacle 2 might not be adjusted to the Y-peak position, as in the X-peak search. In such cases, the position of the receptacle 2 in the Y-axis direction is adjusted to the interim peak position in the Y-axis direction.

At step S6, the Z-peak search is performed in the same manner as the X-peak search and the Y-peak search. In this operation, the photocurrent is detected, while the receptacle 2 is moved relative to the CAN 1 within the range (the first predetermined range) of “a” (μm) in the positive direction from the above initial position in the Z-axis direction and “a” (μm) in the negative direction. The value of “a” used here is the value of “a” for the Z-peak search. For example, the detection of the photocurrent is performed at a predetermined pitch (a 1-μm pitch, for example). The peak value of the photocurrent detected within the first predetermined range is then measured. Such a position in the Z-axis direction that the photocurrent becomes to this peak value is determined as an interim peak position. An attenuation position where the photocurrent shows a predetermined attenuation with respect to the peak value is then measured in each of the positive and negative directions in the Z-axis direction from the interim peak position. More specifically, attenuation positions where the photocurrent attenuates by “b” (%) with respect to the peak value are measured. The value of “b” used here is the value of “b” for the Z-peak search. The attenuation position in the positive direction from the interim peak position is referred to as the first attenuation position, and the attenuation position in the negative direction from the interim peak position is referred to as the second attenuation position. The position that is between the first and second attenuation positions and is located within a second predetermined range from the middle point between the first and second attenuation positions is determined as the peak position (the Z-peak position) in the Z-axis direction. The position of the receptacle 2 in the Z-axis direction is then adjusted to the Z-peak position.

In the Z-peak search, depending on the search conditions, at least one of the first and second attenuation positions might not be measured, the peak position (the Z-peak position) might not be determined, and the position of the receptacle 2 might not be adjusted to the Z-peak position, as in the X-peak search and the Y-peak search. In such cases, the position of the receptacle 2 in the Z-axis direction is adjusted to the interim peak position in the Z-axis direction.

The second predetermined range in the peak search operation is now described. For example, when the position of the receptacle 2 in the X-axis direction is a position where the in-band deviation degradation is within predetermined limits, the photocurrent substantially reaches the peak value. In the example shown in FIG. 14, the position of the receptacle 2 in the X-axis direction is a position where the in-band deviation degradation is 0.5 dB or less, the photocurrent substantially reaches the peak value. In the example shown in FIG. 14, the X-axis direction range in which the in-band deviation degradation is 0.5 dB or less is approximately 12 μm in the positive direction and approximately 12 μm in the negative direction. Accordingly, the second predetermined range in the X-peak search may be 12 μm in this embodiment. The X-peak position may be any position in the range of 12 μm in each of the positive and negative directions from the middle point between the first and second attenuation positions. With the moving time of the receptacle 2 being taken into consideration, the position closest to the present position of the receptacle 2 in the range of 12 μm in each of the positive and negative directions from the middle point between the first and second attenuation positions may be set as the X-peak position. From the same standpoint as that of the second predetermined range in the X-peak search, the second predetermined range in the Z-peak search may be a range of 50 μm in each of the positive and negative directions from the middle point between the first and second attenuation positions, for example. However, those values of course vary with the structure of the optical receiver module 100 and the characteristics of the light-receiving element 5 and so on. The second predetermined range in the Y-peak search is the same as the second predetermined range in the X-peak search.

As described above, in each of the peak searches (the X-, Y-, and Z-peak searches), the peak position may be allowed to have a certain margin. To be specific, however, each of the peak positions (the X-, Y-, and Z-peak positions) may be the middle point between the first and second attenuation positions. In the following description, each peak position is to be determined as the middle point between the first and second attenuation positions.

At step S7, a check is made to determine whether each of the peak positions (the X-peak position, the Y-peak position, and the Z-peak position) has been obtained at step S4, step S5 and step S6. If one or more of the peak positions cannot be obtained (“No” at step S7), step S3 is again carried out to set the values of “a” and “b”. At step S3 carried out this time, at least one of the following setting changes is made: a first setting change to make the value of “a” larger than the value of “a” that is set at step S3 carried out previous time; and a second setting change to make the value of “b” smaller than the value of “b” that is set at step S3 carried out previous time.

Here, only the values of “a” and “b” for the peak search operation in which the peak position cannot be obtained should be changed. For example, if the X-peak position cannot be obtained, at least one of the values of “a” and “b” for the X-peak search should be changed. Likewise, if the Y-peak position cannot be obtained, at least one of the values of “a” and “b” for the Y-peak search should be changed. If the Z-peak position cannot be obtained, at least one of the values of “a” and “b” for the Z-peak search should be changed. In the first setting change to change the value of “a” for each of the X-, Y-, and Z-peak searches, the value of “a” is increased by a predetermined amount (10 (μm), for example). In the second setting change to change the value of “b” for each of the X-, Y-, and Z-peak searches, the value of “b” is reduced by a predetermined amount (1(%), for example).

To prevent false detection of a peak position due to the fluctuation of the photocurrent caused by noise, it is preferable to set the value of “b” for each of the X-, Y-, and Z-peak searches at 2(%) of greater, for example. In a case where a further setting change is made after the value of “b” is reduced to 2(%) through the above setting change, it is preferable to make only the first setting change to increase the search range (to increase the value of “a”). In other words, in a case where the setting change of the fourth procedure is further made after the predetermined attenuation is reduced to a predetermined limit (2 (%), for example), it is preferable to make only the first setting change between the first and second setting changes.

In the setting change at step S3, the first setting change and the second setting change may be made at once. However, when the first setting change and the second setting change are made at once, the search conditions are greatly changed. Therefore, it is preferable to make only one of the first setting change and the second setting change, and cause only a small change in the search conditions.

Where the setting changes have been made in the above described manner, steps S4 through S6 are again carried out, and the operation moves on to the determination at step S7. Thereafter, the setting change of step S3 and the procedures of steps S4 through S6 are repeated until, at step S7, each of the peak positions (the X-peak position, the Y-peak position, and the Z-peak position) is determined to have been obtained.

If each of the peak positions (the X-peak position, the Y-peak position, and the Z-peak position) is determined to have been obtained at step S7 (“Yes” at step S7), the receptacle 2 is fixed to the CAN 1 in the position adjusted through steps S4 through S6 carried out so far (step S8).

Through the above procedures, the receptacle 2 is fixed to the CAN 1 in such a position that the photocurrent becomes substantially equal to the peak value in each of the X-axis direction, the Y-axis direction, and the Z-axis direction. In this manner, the optical receiver module 100 shown in FIG. 1 is obtained.

Referring now to FIGS. 4 and 6, the reasons that the time required for manufacturing the optical receiver module 100 can be shortened according to this embodiment are described.

The curve L1 in FIG. 4 represents the X-axis direction distribution of the light intensity in the emission end face (the output end face) of the optical fiber 16 observed when LD (Laser Diode) light is emitted from the input end of the optical fiber 16 (a MCP that has a GI62.5 multimode fiber as the output end, and a single-mode fiber (SMF) as the input end) connected to the receptacle 2. The curve L2 in FIG. 4 represents the X-axis direction distribution of the light intensity in the emission end face of a SMF that replaces the optical fiber 16 and is connected to the receptacle 2 observed when LD (laser diode) light is emitted from the opposite end face of the SMF from the connected end. As shown in FIG. 4, the light intensity distribution in the fiber output end face is wider in the MCP than in the SMF. The ordinate axis in FIG. 4 indicates the light intensity, with the light intensity in the peak position being 1. In the example shown in FIG. 4, a range in which the light intensity is equal to 1/e² or higher (“e” being the base of natural logarithm) is considered. Here, 1/e² is approximately 0.13. In the example shown in FIG. 4, the range in which the light intensity is equal to 1/e² or higher is approximately ±4.5 μm where a SMF is connected to the receptacle 2, but is approximately ±21.6 μm where a MCP is connected to the receptacle 2. In view of this, it becomes apparent that the light gathered by the lens 12 and emitted onto the light-receiving element 5 has higher light intensity in a wider range in a case where a MCP is connected to the receptacle 2 than in a case where a SMF is connected to the receptacle 2. In short, the spot diameter of the light emitted onto the light-receiving face of the light-receiving element 5 is larger in a case where a MCP is connected to the receptacle 2 than in a case where a SMF is connected to the receptacle 2. Therefore, there is more light sticks out from the light-receiving range of the light-receiving element 5 in a case where a MCP is connected to the receptacle 2 than in a case where a SMF is connected to the receptacle 2, even when each of the X-, Y-, and Z-peak searches is performed in a small search range. Accordingly, the X-, Y-, and Z-tolerance curves become steeper in a case where a MCP is connected to the receptacle 2 than in a case where a SMF is connected to the receptacle 2, though they depend on various conditions (described below).

The following is a detailed description of the reasons that the X-, Y-, and Z-tolerance curves become steeper in a case where a MCP is connected to the receptacle 2 than in a case where a SMF is connected to the receptacle 2.

As example conditions, the spot diameter in a case where a MCP is connected to the receptacle 2 (hereinafter referred to simply as “in the case of a MCP” or the like) is set at 60 μm, the spot diameter in a case where a SMF is connected to the receptacle 2 (hereinafter referred to simply as “in the case of a SMF” or the like) is 20 μm, and the light-receiving diameter of the light-receiving element 5 is 80 μm. In the case of a MCP under those conditions, the spot of light sticks out of the light-receiving range of the light-receiving element 5, only when the receptacle 2 is moved in the X-axis direction or the Y-axis direction so as to move the spot of light a longer distance than 10 μm from the center of the light-receiving range. In the case of a SMF, on the other hand, the spot of light does not stick out of the light-receiving range before the spot of light is moved 30 μm from the center of the light-receiving range. Accordingly, the attenuation of the photocurrent in the case of a MCP has higher dependence on the movement of the receptacle 2 than in the case of a SMF. In other words, under those conditions, the X- and Y-tolerance curves in the case of a MCP are steeper than in the case of a SMF. Next, the Z-tolerance curve under those conditions is described. If the Z-direction dependence or the change rate of the spot diameter depending on the Z-direction movement of the receptacle 2 in the case of a MCP is the same as that in the case of a SMF, the spot of light in the case of a MCP sticks out of the light-receiving range of the light-receiving element 5 with a smaller Z-direction movement than in the case of a SMF. It becomes apparent from the above fact that, under those conditions, the Z-tolerance curve in the case of a MCP is also steeper than in the case of a SMF. In short, under those conditions, the X-, Y-, and Z-tolerance curves in the case of a MCP are steeper than in the case of a SMF. Further, under conditions other than the above, for example, where the spot diameter in the case of a MCP is equal to or smaller than the light-receiving range while the spot diameter in the case of a SMF is smaller than the spot diameter in the case of a MCP, the X-, Y-, and Z-tolerance curves in the case of a MCP are steeper than in the case of a SMF for the same reasons as above. Although the critical conditions are not described here in detail, there are some conditions under which the X-, Y-, and Z-tolerance curves in the case of a MCP are steeper than in the case of a SMF even when the spot diameter in the case of a MCP is larger than the light-receiving range, depending on the relationship with the spot diameter in the case of a SMF. As described above, the X-, Y-, and Z-tolerance curves in the case of a MCP are steeper than in the case of a SMF, though those curves are affected by the relationship among the spot diameter in the case of a MCP, the light-receiving diameter of the light-receiving element 5, and the spot diameter in the case of a SMF.

As described above, in a case where a MCP is connected to the receptacle 2, there is a higher possibility that a position that exhibits the desired attenuation b exists in a smaller search range, than in a case where a SMF is connected to the receptacle 2. Accordingly, a smaller search range can be set. As a result, the time required for core adjustment can be shortened, and the time required for manufacturing the optical receiver module 100 can be shortened.

In a case where a MCP is not used, but a multimode fiber is simply connected to the output end face of a SMF having LD light emitted thereto (or a multimode fiber is additionally joined to the output end face of a SMF having LD light emitted thereto), the spot diameter can be expected to be larger than in the case of a SMF. In such a case, however, the light cannot spread sufficiently in the core of the multimode fiber. Also, the intensity distribution of the light received on the fiber end face might vary due to bending of the fiber or the like. Therefore, it is difficult to control the intensity of the received light in the fiber end face. To counter this problem, in this embodiment, a multimode fiber is not simply connected to the receptacle 2, but a multimode fiber connected (additionally joined) to the multimode fiber of a MCP is connected to the receptacle 2.

FIG. 5 shows the actual measurement values of the X-tolerance of the photocurrent measured by performing X-peak searches where a MCP or a SMF is connected to the receptacle 2, the reverse bias voltage is 3.3V, and the light intensity is set at −10 dBm. The light-receiving element 5 used here has a diffusion diameter W1 of Φ30 μm.

As shown in FIG. 5, the results of measurement of the photocurrent in a search range of ±50 μm show that, in the case where a SMF is connected to the receptacle 2 (the curve L4 of FIG. 5), the value of “b” is 10% or higher in the range of −21 μm to +21 μm in the X-direction position. In the case where a MCP is connected to the receptacle 2 (the curve L3 of FIG. 5), the value of “b” is 10% or lower in the range of −15 μm to +15 μm in the X-direction position. In short, in the case where a SMF is connected to the receptacle 2, an attenuation position that exhibits the desired attenuation b does not exist within the search range, unless the search range is expanded to a ±21 μm range. In the case where a MCP is connected to the receptacle 2, on the other hand, the first and second attenuation positions that exhibit the desired attenuation b exist within a search range set at ±15 μm. Accordingly, the search range in the X-peak search in the case where a MCP is connected to the receptacle 2 can be made smaller than the search range in the X-peak search in the case where a SMF is connected to the receptacle 2. With this arrangement, the time required for the X-peak search can be shortened.

The Y-tolerance curve that is the curve representing the relationship between the position of the receptacle 2 in the Y-axis direction and the photocurrent is neither shown nor described herein, since the Y-tolerance curve is similar to the X-tolerance curve shown in FIG. 5. Accordingly, the search range in the Y-peak search in the case where a MCP is connected to the receptacle 2 can be made smaller than the search range in the Y-peak search in the case where a SMF is connected to the receptacle 2. With this arrangement, the time required for the Y-peak search can be shortened.

FIG. 6 shows the actual measurement values of the photocurrent measured by performing Z-peak searches where a MCP or a SMF is connected to the receptacle 2, the reverse bias voltage is 3.3 V, and the light intensity is set at −10 dBm. To prevent false detection of a peak position due to a fluctuation of the photocurrent caused by noise as described above, it is preferable to set the value of “b” for the Z-peak searches at 2(%) or higher.

As shown in FIG. 6, the results of measurement of the photocurrent in a search range of ±200 μm show that, in the case where a SMF is connected to the receptacle 2 (the curve L6 of FIG. 6), there is not a position where the value of “b” is equal to 2% or higher. In the case where a MCP is connected to the receptacle 2 (the curve L5 of FIG. 6), the value of “b” is equal to 2% or higher in the range of Z-direction position is equal to −100 μm or smaller, and is equal to +80 μm or greater. In short, in the case where a SMF is connected to the receptacle 2, an attenuation position that exhibits the desired attenuation b does not exist within the search range, even though the search range is expanded to a ±200 μm range. In the case where a MCP is connected to the receptacle 2, on the other hand, the first and second attenuation positions that exhibit the desired attenuation b exist within a search range set at ±100 μm. Accordingly, the search range in the Z-peak search in the case where a MCP is connected to the receptacle 2 can be made smaller than the search range in the Z-peak search in the case where a SMF is connected to the receptacle 2. With this arrangement, the time required for the Z-peak search can be shortened.

In any of the X-, Y-, and Z-peak searches (or in any of the cases shown in FIGS. 5 and 6), the tolerance curve in the case where a MCP is connected to the receptacle 2 can be made steeper than in the case where a SMF is connected to the receptacle 2, so that the value of the desired attenuation “b” can be set at a larger value. Accordingly, false detection of a peak position due to noise can be suppressed. Furthermore, since the tolerance curves can be made steeper, the peak positions can be detected with high precision, and the yield rate in the frequency response characteristics of the optical receiver module 100 can be improved. Moreover, since the search ranges can be made smaller, the relative movement distances of the receptacle 2 and the CAN 1 can be made shorter. Accordingly, the desired attenuation b can be achieved, without interference between the receptacle 2 and the CAN 1.

When optical receiver modules 100 having the same size, the same shape, and the same characteristics are manufactured in a continuous manner, the second and later optical receiver modules 100 are manufactured with the use of the light intensity and the reverse bias voltage used for manufacturing the first optical receiver module 100, and the values of “a” and “b” set at the end in the manufacture of the first optical receiver module 100. In this manner, the time required for manufacturing the second and later optical receiver modules 100 can be shortened further. More specifically, the optical receiver modules 100 can be manufactured, with the fourth procedure being skipped, for example.

Referring now to FIG. 7, the structure of a optical receiver module manufacturing apparatus 150 according to this embodiment is described.

The optical receiver module manufacturing apparatus 150 according to this embodiment is an apparatus that implements the above described method for manufacturing a optical receiver module (the manufacturing method according to the flowchart shown in FIG. 3) according to this embodiment. The optical receiver module manufacturing apparatus 150 has the structure illustrated in FIG. 7, for example. More specifically, the optical receiver module manufacturing apparatus 150 includes a first holding unit 151, a second holding unit 152, a relative position adjustment unit 153, a photocurrent detection unit 154, a light intensity setting unit 161, a reverse bias voltage application unit 155, a control unit 156, a storage unit 157, a display unit 158, an operation unit 159, and a fixing unit 160.

The first holding unit 151 holds the receptacle 2, and the second holding unit 152 holds the CAN package 1.

The relative position adjustment unit 153 adjusts the relative positions of the receptacle 2 and the CAN package 1 by moving the first holding unit 151 and the second holding unit 152 in a relative manner. More specifically, the relative position adjustment unit 153 moves the receptacle 2 relative to the CAN package 1, to adjust the relative positions of the receptacle 2 and the CAN package 1. The relative position adjustment unit 153 may be formed with a pulse motor, for example.

The photocurrent detection unit 154 is connected to an output terminal (not shown) of the light-receiving element 5, and detects the photocurrent.

The light intensity setting unit 161 is connected to a laser diode (LD) (not shown) that supplies light to the optical fiber 16. The light intensity setting unit 161 adjusts the light emission from the laser diode or uses an optical attenuator, to set the intensity of the light emitted from the optical fiber 16.

The reverse bias voltage application unit 155 is connected to a reverse bias voltage input terminal (not shown) of the light-receiving element 5, and applies a reverse bias voltage to the reverse bias voltage input terminal. Under the control of the control unit 156, the reverse bias voltage application unit 155 can change the value of the reverse bias voltage to be applied to the reverse bias voltage input terminal of the light-receiving element 5.

The fixing unit 160 fixes the receptacle 2 and the CAN package 1 relative to each other in the core adjusted position. Although not shown in the drawing, the fixing unit 160 includes a storing unit that stores an adhesive agent, and a discharging unit that has a smaller diameter than the storing unit and discharges the adhesive agent from its top end. The fixing unit 160 applies the adhesive agent into the gap between the inner circumference of the cylindrical fixing unit 13 of the receptacle 2 and the outer circumferential face of the CAN package 1. By doing so, the fixing unit 160 fixes the receptacle 2 and the CAN package 1 to each other with the adhesive agent.

The control unit 156 collectively controls the respective components of the optical receiver module manufacturing apparatus 150. More specifically, the control unit 156 controls the operations of the relative position adjustment unit 153, the light intensity setting unit 161, the reverse bias voltage application unit 155, the storing unit 157, the display unit 158, and the fixing unit 160. As the control unit 156 controls the operation of the relative position adjustment unit 153, the relative position of the receptacle 2 relative to the CAN package 1 can be adjusted. As the control unit 156 controls the operation of the light intensity setting unit 161, the intensity of the light emitted from the optical fiber 16 can be adjusted. As the control unit 156 controls the operation of the reverse bias voltage unit 155, the value of the reverse bias voltage to be applied to the light-receiving element 5 can be adjusted. As the control unit 156 controls the operation of the fixing unit 160, the receptacle 2 and the CAN package 1 can be fixed to each other. Further, the control unit 156 performs a calculating operation based on the photocurrent detected by the photocurrent detection unit 154. Through this calculating operation, the control unit 156 can determine the X-tolerance curve, the Y-tolerance curve, and the Z-tolerance curve, can determine the first and second attenuation positions in each of the adjustment directions (the X-axis direction, the Y-axis direction, and the Z-axis direction), and can determine each of the peak positions (the X-peak position, the Y-peak position, and the Z-peak position).

The control unit 156 includes a CPU (Central Processing Unit), a ROM (Read Only Memory) storing an operating program for the CPU, and a RAM (Random Access Memory) functioning as a work area or the like for the CPU. The CPU operates according to the operating program stored in the ROM, and performs various kinds of control operations and calculating operations.

The display unit 158 performs various kinds of display, to assist a parameter input operation of an operator and the likes. More specifically, the display unit 158 displays an input screen to assist an operation to input the values of the reverse bias voltage and the light intensity, as well as the above initial values of “a” and “b” (the value “a” and the attenuation value “b” in the first execution of step S3). While checking the display screen of the display unit 158, the operator performs a predetermined operation on the operation unit 159, to input the initial values of “a” and “b”, and the values of the reverse bias voltage and the light intensity.

The storage unit 157 stores the changed values of “a” and “b”, and the value of the photocurrent detected by the photocurrent detection unit 154, as well as the input initial values of “a” and “b”, and the values of the reverse bias voltage and the light intensity.

With the optical receiver module manufacturing apparatus 150 having the above structure, the method for manufacturing an optical receiver module according to this embodiment can be implemented by the control unit 156 operating in the following manner.

As described above, the control unit 156 carries out: the core adjusting process (steps S1 through S7 of FIG. 3, for example) to adjust the relative positions of the receptacle 2 and the CAN package 1 including: determining the peak position in which the photocurrent reaches the peak value in the predetermined adjustment direction, while light is emitted from the optical fiber 16 to the light-receiving element 5 through the lens 12; and adjusting the relative positions; and the fixing process (step S8 of FIG. 3) to fix the receptacle 2 and the CAN package 1 to each other in the positions adjusted through the core adjusting process. The core adjusting process includes: the first procedure (the X-peak search of step S4) to determine the peak position, while the adjustment direction is set to one direction (the X-axis direction) in the plane perpendicular to the core direction (the Z-axis direction) of the optical fiber 16, and adjusting the relative positions to the peak position; and the second procedure (the Y-peak search of step S5) to determine the peak position, while the adjustment direction is set to the direction (the Y-axis direction) perpendicular to the one direction in the plane, and adjusting the relative positions to the peak position; and the third procedure (the Z-peak search of step S6) to determine the peak position, while the adjustment direction is set to the core direction (the Z-axis direction), and adjusting the relative positions to the peak position. In each of the first through third procedures is carried out by performing the specific core adjusting process. The specific core adjusting process includes: detecting the photocurrent, while moving the receptacle 2 and the CAN package 1 relative to each other in the adjustment direction within the first predetermined range, while using the multimode fiber of the MCP or the multimode fiber connected to the MCP as the optical fiber 16; determining whether, there exist the first attenuation position and the second attenuation position in which the photocurrent shows the predetermined attenuation compared with the peak value within the first predetermined range, at in both directions of the adjustment direction from the interim peak position in which the photocurrent reaches the peak value within the first predetermined range. If there exist the first attenuation position and the second attenuation position, determining the peak position that is the arbitrary position located between the first attenuation position and the second attenuation position, and is located within the second predetermined range from the middle point between the first attenuation position and the second attenuation position. When at least one of the first and second attenuation positions is determined not to exist through at lest one of the first through third procedures, the control unit 156 carries out the fourth procedure of making at least one of the first setting change to enlarge the search range in the procedure (one of the first through third procedures) at which at least one of the first and second attenuation positions is determined not to exist, and the second setting change to reduce the attenuation “b” at the corresponding procedure (one of the first through third procedures). After carrying out the fourth procedure, the control unit 156 again carries out the first through third procedures. In this manner, the light-receiving manufacturing apparatus 150 implements the above described method for manufacturing an optical receiver module according to this embodiment. The operations in each of the later described modifications can be realized by the CPU of the control unit 156 operating according to the operating program for realizing the respective operations, for example.

According to the above described first embodiment, to manufacture the optical receiver module 100, the core adjusting process (steps S1 through S6 of FIG. 3, for example) is performed to adjust the relative positions of the receptacle 2 and the CAN package 1, including: determining a peak position in which a photocurrent generated by the light-receiving element 5 reaches a peak value in a predetermined adjustment direction, while light is emitted from the optical fiber 16 to the light-receiving element 5 through the lens 12; and adjusting the relative positions; and a fixing process (step S8 of FIG. 3) to fix the receptacle 2 and the CAN package 1 to each other in the positions adjusted through the core adjusting process. The core adjusting process includes: the first procedure to determine the peak position, while the adjustment direction is set to the X-axis direction, and adjusting the relative positions to the peak position; and the second procedure to determine the peak position, while the adjustment direction is set to the Y-axis direction, and adjusting the relative positions to the peak position; and the third procedure to determine the peak position, while the adjustment direction is set to the Z-axis direction, and adjusting the relative positions to the peak position. Each of the first through third procedures is carried out by performing a specific core adjusting process. The specific core adjusting process includes: detecting the photocurrent generated by the light-receiving element 5, while moving the receptacle 2 and the CAN package 1 relative to each other in the adjustment direction within a first predetermined range, while using a multimode fiber of a MCP (Mode Conditioning Patch cord) or using a multimode fiber connected to the MCP as the optical fiber 16. A check is then made to determine whether there exist each of the first attenuation position and the second attenuation position exhibiting the desired attenuations by comparing the photocurrent with a peak value, at in both directions of the adjustment direction from the interim peak position in which the photocurrent reaches the peak value within the first predetermined range. If there are the first attenuation position and the second attenuation position, the peak position is calculated as a position that is located between the first attenuation position and the second attenuation position, and is within the second predetermined range from the middle point between the first and second attenuation positions.

With the above arrangement, the light in the light-receiving face of the light-receiving element 5 can spread more widely than in a case where the light-receiving element 5 receives the light emitted from a SMF through the lens 12. Accordingly, each of the tolerance curves in the X-, Y-, and Z-axis directions can be made steeper than in the case where the light-receiving element 5 receives the light emitted from a SMF through the lens 12. As a result of this, the first predetermined range in which the receptacle 2 and the CAN 1 are moved relative to each other to achieve the desired attenuation can be made narrower than in the case where the light-receiving element 5 receives the light emitted from a SMF through the lens 12. Accordingly, the core adjustment can be performed in a shorter period of time, and the time required for manufacturing the optical receiver module 100 can be shortened. Since the tolerance curve in each direction can be made steeper than in the case where the light-receiving element 5 receives the light emitted from a SMF through the lens 12, the value of the desired attenuation “b” can be set at a greater value. Accordingly, false detection of a peak position due to an adverse influence of noise can be prevented. Furthermore, since the tolerance curve in each direction can be made steeper, the peak position can be detected with high precision, and the yield rate in the frequency response characteristics of the optical receiver module 100 can be improved.

### <First Modification>

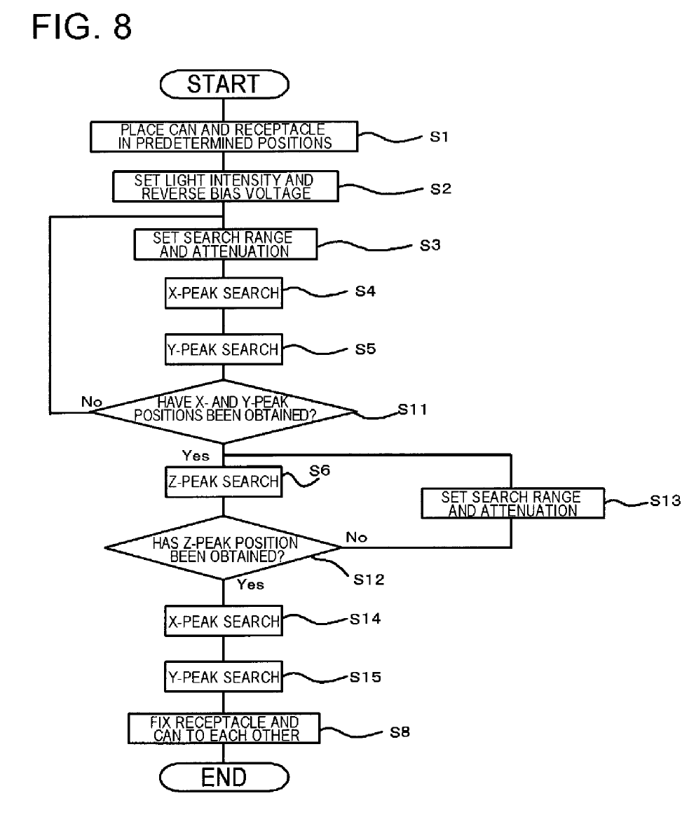

FIG. 8 is a flowchart showing a method for manufacturing an optical receiver module according to a first modification.

By the manufacturing method according to the first modification, a sixth procedure is carried out to carry out the first and second procedures so as to determine peak positions in the X-axis direction and the Y-axis direction, and adjust the relative positions of the receptacle 2 and the CAN 1 to those peak positions. A seventh procedure is then carried out to carry out the third procedure so as to determine a peak position in the Z-axis direction, and adjust the relative positions of the receptacle 2 and the CAN 1 to the peak position. An eighth procedure is then carried out to carry out the first and second procedures. The fourth procedure is not carried out between the seventh procedure and the eighth procedure.

By the manufacturing method according to the first modification, steps S1 through S5 are carried out in the same manner as in the first embodiment, but step S11 is carried out after step S5.

At step S11, a check is made to determine whether each of the peak positions (the X-peak position and the Y-peak position) has been obtained at steps S4 and S5. In a case where at least one of the peak positions has not been obtained (“No” at step S11), the setting change of step S3 is performed. At step S3 to be carried out this time, at least one of the following setting changes is made: the first setting change to make the search range larger (or wider) than the search range that is set at step S3 carried out previous time, and the second setting change to make the necessary attenuation smaller than the attenuation that is set at step S3 carried out previous time. Here, only the values of “a” and “b” for the peak search operation by which a peak position has not been obtained should be changed. For example, in a case where the X-peak position has not been obtained, at least one of the values of “a” and “b” for the X-peak search should be changed. In a case where the Y-peak position has not been obtained, at least one of the values of “a” and “b” for the Y-peak search should be changed. Meanwhile, there is no need to change the values of “a” and “b” for the Z-peak search.

With the above setting changes being made, steps S4 and S5 are carried out again, and the operation moves on to the determination at step S11. Thereafter, the setting change of step S3 and steps S4 and S5 are repeated until, at step S11, each of the peak positions (the X-peak position and the Y-peak position) is determined to have been obtained (until the result of step S11 becomes “Yes”).

After each of the peak positions (the X-peak position and the Y-peak position) is determined to have been obtained (“Yes” at step S11), the operation moves on to step S6, and the same Z-peak search as that of the first embodiment is performed.

At step S12 following step S6, a check is made to determine whether the Z-peak position has been obtained at step S6. In a case where the Z-peak position has not been obtained (“No” at step S12), the setting change of step S13 is performed. This setting change is performed in the same manner as in the setting change of step S3. More specifically, at least one of the following setting changes is made: the first setting change to make the search range larger (or wider) than the search range that is set at step S3 carried out previous time, and the second setting change to make the necessary attenuation smaller than the attenuation that is set at step S3 carried out previous time. Here, only the values of “a” and “b” for the Z-peak search, and there is no need to change the values of “a” and “b” for the X-peak search and the Y-peak search.

With the above setting changes being made, step S6 is carried out again, and the operation moves on to the determination at step S12. Thereafter, the setting change of step S13 and step S6 are repeated until, at step S12, the Z-peak position is determined to have been obtained (until the result of step S12 becomes “Yes”).

If the optical axis 19 of the light emitted from the lens 12 to the light-receiving element 5 deviates from the core direction of the optical fiber 16, the positions of the receptacle 2 in the X-axis direction and the Y-axis direction adjusted by the previous X-peak search and Y-peak search slightly deviate from the respective peak positions when the Z-axis direction position shifts due to the Z-peak search.

Therefore, in the first modification, when the Z-peak position is determined to have been obtained (“Yes” at step S12), the operation moves on to step S14, and the same X-peak search as that of step S4 is performed. The operation then moves on to step S15, and the same Y-peak search as that of step S5 is performed. In this manner, the positions of the receptacle 2 in the X-axis direction and the Y-axis direction are readjusted.

After that, the operation moves on to step S8, and the receptacle 2 is fixed to the CAN 1 in the position adjusted through steps S6, S14, and S15 carried out so far. In this manner, the optical receiver module 100 of FIG. 1 is obtained.

Although not described in detail, the above manufacturing method according to the first modification can be implemented by the above described optical receiver module manufacturing apparatus 150.

According to the first modification, after the Z-peak position is obtained, the X-peak search of step S14 and the Y-peak search of step S15 are performed. Accordingly, if the optical axis 19 deviates from the core direction of the optical fiber 16, the positions of the receptacle 2 in the X-axis direction and the Y-axis direction can be adjusted to the X-peak position and the Y-peak position with higher precision than in the first embodiment.

### <Second Modification>

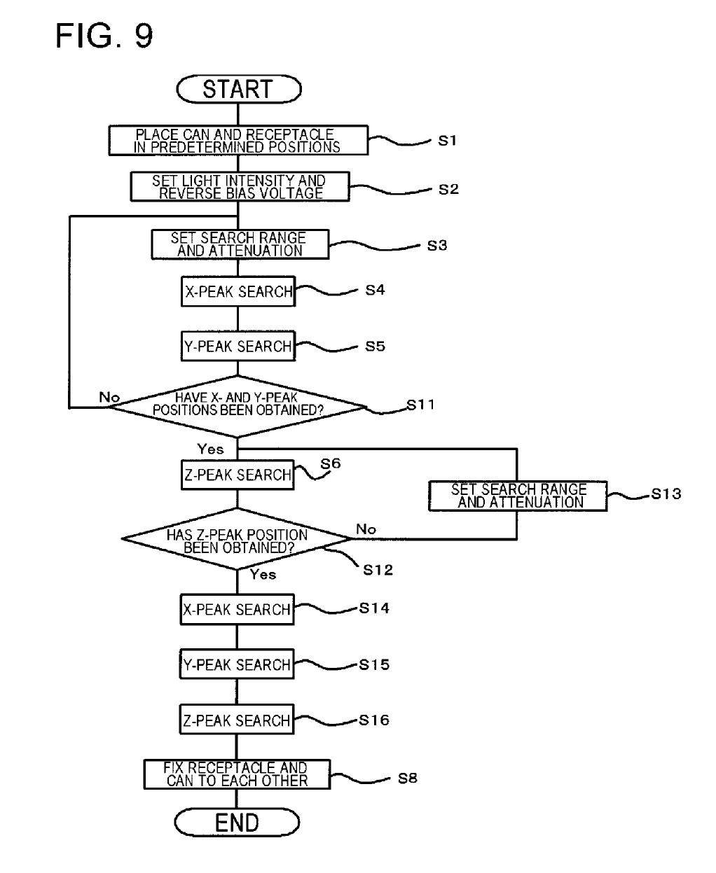

FIG. 9 is a flowchart showing a method for manufacturing an optical receiver module according to a second modification.

By the manufacturing method according to the second modification, after the eighth procedure of the first modification is carried out, the third procedure is carried out as a ninth procedure, with the fourth procedure being not carried out between the eighth procedure and the ninth procedure.

By the manufacturing method according to the second modification, steps S1 through S15 are carried out in the same manner as in the first modification.

After the X-peak search of step S14 and the Y-peak search of step S15 are performed, the position of the receptacle 2 in the Z-axis direction adjusted at step S6, which is previously carried out, slightly deviates from the peak position.

Therefore, in the second modification, the operation moves onto step S16 after step S15, and the same Z-peak search as that of step S6 is performed. In this manner, the position of the receptacle 2 in the Z-axis direction is readjusted.

After that, the operation moves on to step S8, and the receptacle 2 is fixed to the CAN 1 in the position adjusted through steps S14, S15, and S16 carried out so far. In this manner, the optical receiver module 100 of FIG. 1 is obtained.

Although not described in detail, the above manufacturing method according to the second modification can also be implemented by the above described optical receiver module manufacturing apparatus 150.

According to the second modification, after the X-peak position and the Y-peak position are readjusted, the Z-peak position is also readjusted. Accordingly, if the optical axis 19 deviates from the core direction of the optical fiber 16, the position of the receptacle 2 in the Z-axis direction can be adjusted to the Z-peak position with higher precision than in the first modification.

### <Third Modification>

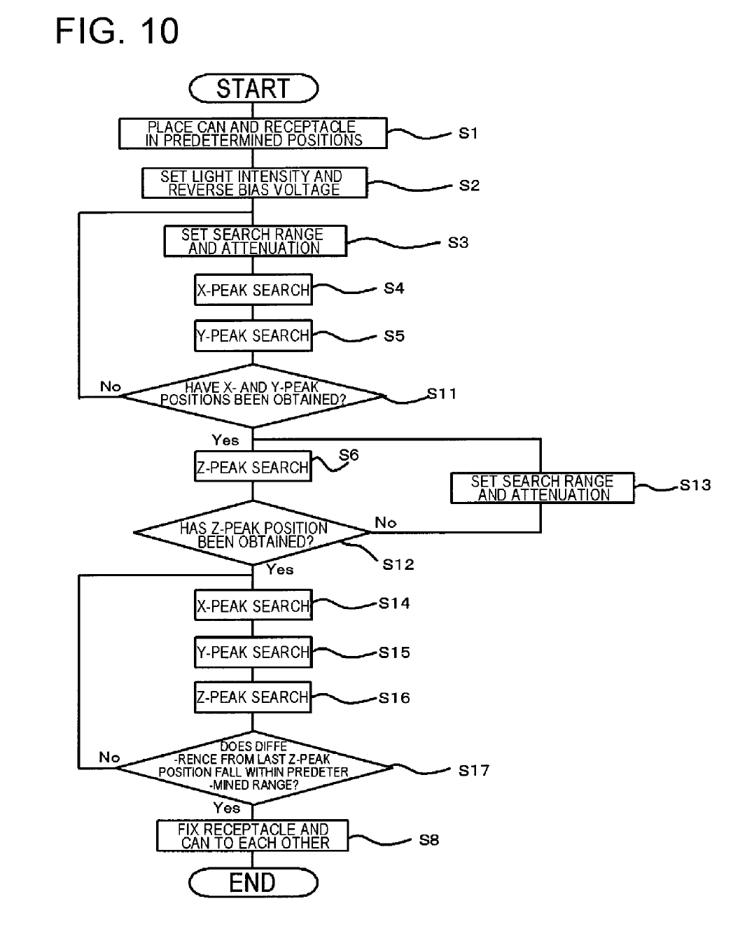

FIG. 10 is a flowchart showing a method for manufacturing an optical receiver module according to a third modification.

By the manufacturing method according to the third modification, the eighth procedure and the ninth procedure are repeated until the difference between the peak position determined at the previous seventh procedure and the peak position determined at the ninth procedure carried out last time falls within a predetermined error range.

By the manufacturing method according to the third modification, steps S1 through S16 are carried out in the same manner as in the second modification.

The X-peak position, the Y-peak position, and the Z-peak position might not be adjusted to the respective peak positions with high precision simply by carrying out step S14 (the X-peak search), step S15 (the Y-peak search), and step S16 (the Z-peak search) only once each after step S12.

In the third modification, the operation moves on to step S17 after step S16. At step S17, a check is made to determine whether the Z-peak position newly determined at step S16 is within a predetermined error range from the Z-peak position determined by the previous Z-peak search (step S6 carried out previous time or step S16 carried out previous time). More specifically, at step S17, a check is made to determine whether the difference between the newly determined Z-peak position and the Z-peak position determined by the previous Z-peak search is equal to 10 μm or less.

If the newly determined Z-peak position is determined not to be within the predetermined error range from the Z-peak position determined by the previous Z-peak search (or determined to be outside the predetermined error range) (“No” at step S17), steps S14, S15, and S16 are carried out again, and the operation moves on to the determination at step S17. Thereafter, steps S14, S15, and S16 are repeated until, at step S17, the newly determined Z-peak position is determined to be within the predetermined error range (until the result of step S17 becomes “Yes”).

If the newly determined Z-peak position is determined to be within the predetermined error range from the Z-peak position determined by the previous Z-peak search (“Yes” at step S17), the operation moves on to step S8, and the receptacle 2 is fixed to the CAN 1 in the position adjusted through steps S14, S15, and S16 carried out so far. In this manner, the optical receiver module 100 is obtained.

Although not described in detail, the above manufacturing method according to the third modification can also be implemented by the above described optical receiver module manufacturing apparatus 150.

According to the third modification, the determination at step S17 is carried out after steps S14 through S16, and steps S14 through S16 are repeated if necessary. Accordingly, if the optical axis 19 deviates from the core direction of the optical fiber 16, the X-peak position, the Y-peak position, and the Z-peak position can be adjusted to the peak position with higher precision than in the second modification.

### <Fourth Modification>

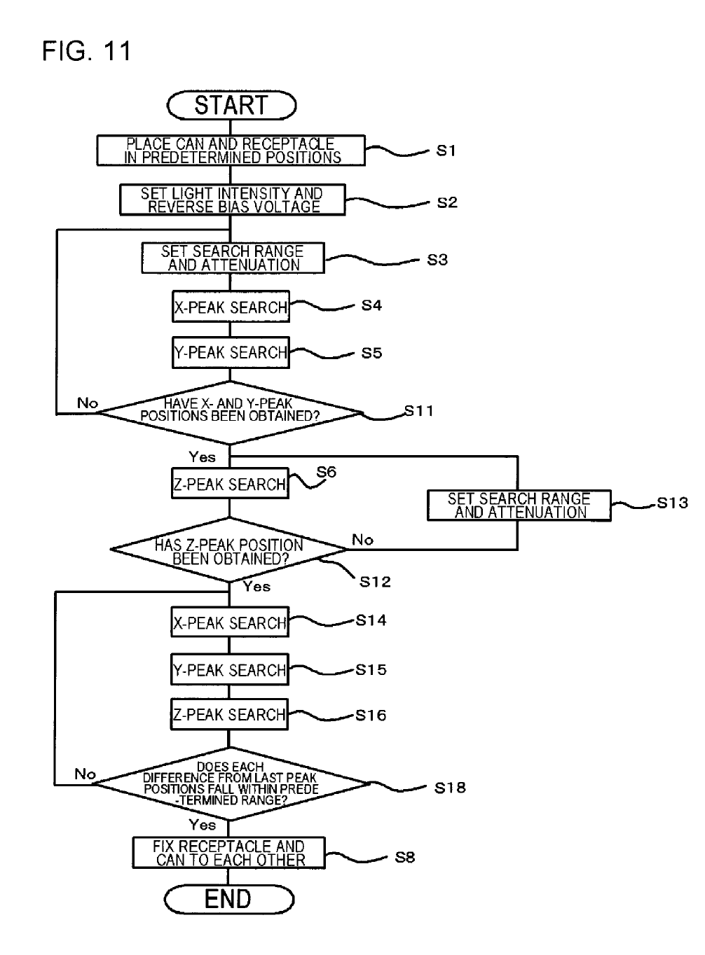

FIG. 11 is a flowchart showing a method for manufacturing an optical receiver module according to a fourth modification.

By the manufacturing method according to the fourth modification, the eighth and the ninth procedures are repeated until the difference between the peak position determined by the first procedure carried out previous time and the peak position newly determined by the first procedure of the eighth procedure carried out last time falls within a predetermined error range, and the difference between the peak position determined by the second procedure carried out previous time and the peak position newly determined by the second procedure of the eighth procedure carried out last time is within a predetermined error range.

The manufacturing method according to the fourth modification differs from the manufacturing method according to the third modification in that step S18 is carried out in place of step S17. Other than that, the manufacturing method according to the fourth modification is the same as the manufacturing method according to the third modification.

At step S18, a check is made to determine whether the peak positions newly determined at step S14, S15, and S16 carried out last time are within predetermined error range from the X-, Y-, and Z-peak positions determined by the peak searches performed previous time. As for the X-peak position, a check is made to determine whether the newly determined X-peak position is within a predetermined error range (2 μm, for example) from the X-peak position determined by the X-peak search performed previous time (step S4 carried out previous time, or step S14 carried out previous time). As for the Y-peak position, a check is made to determine whether the newly determined Y-peak position is within a predetermined error range (2 μm, for example) from the Y-peak position determined by the Y-peak search performed previous time (step S5 carried out previous time, or step S15 carried out previous time). As for the Z-peak position, a check is made to determine whether the newly determined Z-peak position is within a predetermined error range (10 μm, for example) from the Z-peak position determined by the Z-peak search performed previous time (step S6 carried out previous time, or step S16 carried out previous time).

If even one of the newly determined peak positions is determined not to be within the predetermined error range from the peak position determined by the previous peak search (or determined to be outside the predetermined error range) (“No” at step S18), steps S14, S15, and S16 are carried out again, and the operation moves on to the determination at step S18. Thereafter, steps S14, S15, and S16 are repeated until, at step S18, each of the newly determined peak positions is determined to be within the predetermined error range (until the result of step S18 becomes “Yes”).

If each of the newly determined peak positions is determined to be within the predetermined error range from each corresponding peak position determined by the previous peak searches (“Yes” at step S18), the operation moves on to step S8, and the receptacle 2 is fixed to the CAN 1 in the position adjusted through steps S14, S15, and S16 carried out so far. In this manner, the optical receiver module 100 is obtained.

Although not described in detail, the above manufacturing method according to the fourth modification can also be implemented by the above described optical receiver module manufacturing apparatus 150.

According to the fourth modification, the determination at step S18 is carried out after steps S14 through S16, and steps S14 through S16 are repeated if necessary. Accordingly, if the optical axis 19 deviates from the core direction of the optical fiber 16, the X-peak position, the Y-peak position, and the Z-peak position can be adjusted to the peak position with higher precision than in the third modification.

### Second Embodiment

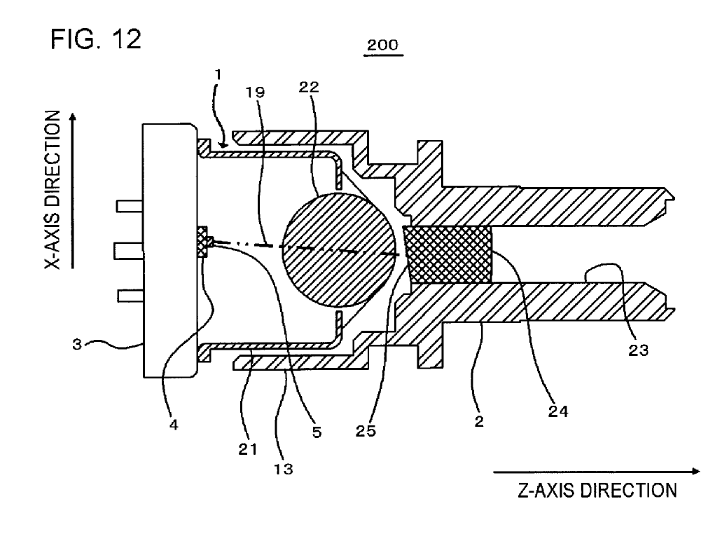

In the above first embodiment, a method for manufacturing an optical receiver module is applied to the optical receiver module 100 having the lens 12 built in the receptacle 2. In the second embodiment, on the other hand, a method for manufacturing an optical receiver module is applied to an optical receiver module 200 having the structure shown in FIG. 12.

As shown in FIG. 12, the optical receiver module 200, to which the method for manufacturing an optical receiver module according to this embodiment is applied, includes a CAN 1 and a receptacle 2 (without a built-in lens).

The CAN 1 includes the same stem 3, the same carrier 4, and the same light-receiving element 5 as those of the first embodiment. In this embodiment, a trans-impedance amplifier, a capacitor, and the likes, as well as the carrier 4 and the light-receiving element 5, may be mounted on the stem 3.

In this embodiment, the CAN 1 has a cap 21, instead of the cap 6 of the first embodiment. The cap 21 is integrally formed with a lens 22 that gathers the light emitted from the optical fiber 16 (see FIG. 2). In this embodiment, the components (such as the carrier 4 and the light-receiving element 5) placed on the stem 3 are also hermetically sealed with the cap 21, to form the CAN 1.

The receptacle 2 includes an optical connector insertion portion 23 and a cylindrical fixing portion 13. In this embodiment, the receptacle 2 does not include a SMF (Single-Mode Fiber) stub either. However, a fiber stop 24 for positioning the optical fiber 16 (see FIG. 2) is provided at a deep location in the optical connector insertion portion 23. More specifically, an optical connector 14 (see FIG. 2) is inserted into the optical connector insertion portion 23, and the front end of the optical connector 14 is stopped by the right end face of the fiber stop 24, as shown in FIG. 12. In this manner, the optical connector 14 is positioned inside the optical connector insertion portion 23. The fiber stop 24 may be made of glass that transmits light, or may be formed with a metal member that has a hole for transmitting light.

The face 25 of the fiber stop 24 on the side of the lens 22 crosses (or deviates from) the plane perpendicular to the Z-axis. Therefore, the optical axis 19 of the light emitted onto the light-receiving element 5 through the fiber stop 24 and the lens 22 crosses (or deviates from) the Z-axis.

In this embodiment, the optical receiver module 200 can be manufactured by the manufacturing method according to the first embodiment or any of the first through fourth modifications. Particularly, since the optical axis 19 deviates from the Z-axis direction in this embodiment as described above, it is preferable to manufacture the optical receiver module 200 by one of the manufacturing methods according to the first through fourth modifications.

The above described second embodiment can achieve the same effects as those of the first embodiment or any of the first through fourth modifications.

If the optical axis 19 of the light emitted from the lens 12 or 22 to the light-receiving element 5 matches the core direction of the optical fiber 16, the methods according to the first through fourth modifications are unnecessary, and the optical receiver module can be manufactured by the manufacturing method according to the first embodiment.

It is apparent that the present invention is not limited to the above embodiment, and may be modified and changed without departing from the scope and spirit of the invention.

What is claimed is:

1. A method for manufacturing an optical receiver module that includes a receptacle to which an optical connector holding an optical fiber is inserted, a lens that gathers light emitted from said optical fiber, and a CAN package including a planar PIN-PD as a light-receiving element that receives the light gathered by said lens,
said method comprising:
adjusting relative positions of said receptacle and said CAN package including: determining a peak position in which a photocurrent generated by said light-receiving element reaches a peak value in a predetermined adjustment direction, while light is emitted from said optical fiber to said light-receiving element through said lens; and adjusting said relative positions to said peak position; and
fixing said receptacle and said CAN package to each other in a position adjusted through said adjusting said relative positions,
said adjusting said relative positions including:
a first procedure to determine said peak position, while said adjustment direction is set to one direction in a plane perpendicular to a core direction of said optical fiber, and adjusting said relative positions to said peak position; and
a second procedure to determine said peak position, while said adjustment direction is set to a direction perpendicular to said one direction in said plane, and adjusting said relative positions to said peak position; and
a third procedure to determine said peak position, while said adjustment direction is set to said core direction, and adjusting said relative positions to said peak position; and
at least one of said first through third procedures being carried out by performing a specific core adjusting process, said specific core adjusting process including:
detecting the photocurrent, while moving said receptacle and said CAN package relative to each other in said adjustment direction within a first predetermined range, while using a multimode fiber of a MCP (Mode Conditioning Patch cord) or using a multimode fiber connected to said MCP as said optical fiber; and
determining whether, there exist a first attenuation position and a second attenuation position in which said photocurrent shows a predetermined attenuation compared with said peak value within said first predetermined range, at in both directions of said adjustment direction from an interim peak position in which said photocurrent reaches said peak value within said first predetermined range; when there exist said first attenuation position and said second attenuation position, determining said peak position that is an arbitrary position located between said first attenuation position and said second attenuation position, and is located within a second predetermined range from a middle point between said first attenuation position and said second attenuation position.

2. The method as claimed in claim 1, wherein,
when at least one of said first attenuation position and said second attenuation position is determined not to exist in said at least one of said first through third procedures, a fourth procedure is carried out to perform at least one of a first setting change and a second setting change, and said at least one of said first through third procedures is again carried out,
said first setting change being made to widen said first predetermined range, said second setting change being made to reduce said predetermined attenuation.

3. The method as claimed in claim 1, wherein each of said first through third procedures is carried out by performing said specific core adjusting process.

4. The method as claimed in claim 3, wherein
said adjusting the relative positions includes
a fifth procedure to carry out said first through third procedures in arbitrary order, with said fourth procedure being not carried out, and
when said peak position cannot be determined because at least one of said first attenuation position and said second attenuation position is determined not to exist in at least one of said first through third procedures in said fifth procedure, the fifth procedure is again carried out after said fourth procedure is carried out.

5. The method as claimed in claim 3, wherein
said adjusting the relative positions includes:
a sixth procedure to carry out said first and second procedures to determine said peak position in said one direction in the plane perpendicular to said core direction and said peak position in said perpendicular direction, and adjust the relative positions of said receptacle and said CAN package to said peak positions;
a seventh procedure to carry out said third procedure to determine said peak position in said core direction, and adjust the relative positions of said receptacle and said CAN package to said peak positions; and
an eighth procedure to carry out said first and second procedures,
said sixth, seventh, and eighth procedures being carried out in this order, with said fourth procedure being not carried out between said seventh procedure and said eighth procedure.

6. The method as claimed in claim 5, wherein said third procedure is carried out as a ninth procedure after said eighth procedure, with said fourth procedure being not carried out between said eighth procedure and said ninth procedure.

7. The method as claimed in claim 6, wherein said eighth procedure and said ninth procedure are repeated until a difference between said peak position determined in said seventh procedure carried out previous time and a peak position determined in said ninth procedure carried out last time falls within a predetermined error range.

8. The method as claimed in claim 6, wherein
said eighth procedure and said ninth procedure are repeated until a difference between said peak position determined in said first procedure carried out previous time and a peak position determined in said first procedure in said eighth procedure carried out last time falls within a predetermined error range, and a difference between said peak position determined in said second procedure carried out previous time and a peak position determined in said second procedure in said eighth procedure carried out last time falls within a predetermined error range.

9. The method as claimed in claim 5, wherein an optical axis of light emitted from said lens to said light-receiving element deviates from said core direction.

10. The method as claimed in claim 1, wherein an optical axis of light emitted from said lens to said light-receiving element matches said core direction.

11. The method as claimed in claim 1, wherein a middle point between said first attenuation position and said second attenuation position is set as said peak position in said specific core adjusting process.

12. An apparatus for manufacturing an optical receiver module that includes a receptacle to which an optical connector holding an optical fiber is inserted, a lens that gathers light emitted from said optical fiber, and a CAN package including a planar PIN-PD as a light-receiving element that receives the light gathered by said lens,
said apparatus comprising:
a first holding unit that holds said receptacle;
a second holding unit that holds said CAN package;
a relative position adjustment unit that adjusts relative positions of said receptacle and said CAN package by moving said first holding unit and said second holding unit relative to each other;
a photocurrent detection unit that detects a photocurrent generated by said light-receiving element; and
a control unit that performs a control operation including operation control of said relative position adjustment unit, and a calculating operation based on the photocurrent detected by said photocurrent detection unit,
said control unit carries out:
adjusting relative positions of said receptacle and said CAN package including: determining a peak position in which a photocurrent generated by said light-receiving element reaches a peak value in a predetermined adjustment direction, while light is emitted from said optical fiber to said light-receiving element through said lens; and adjusting said relative positions to said peak position; and
fixing said receptacle and said CAN package to each other in a position adjusted through said adjusting said relative positions,
said adjusting said relative positions including:
a first procedure to determine said peak position, while said adjustment direction is set to one direction in a plane perpendicular to a core direction of said optical fiber, and adjusting said relative positions to said peak position; and
a second procedure to determine said peak position, while said adjustment direction is set to a direction perpendicular to said one direction in said plane, and adjusting said relative positions to said peak position; and
a third procedure to determine said peak position, while said adjustment direction is set to said core direction, and adjusting said relative positions to said peak position; and
at least one of said first through third procedures being carried out by performing a specific core adjusting process, said specific core adjusting process including:
detecting the photocurrent generated by said light-receiving element, while moving said receptacle and said CAN package relative to each other in said adjustment direction within a first predetermined range, while using a multimode fiber of a MCP (Mode Conditioning Patch cord) or using a multimode fiber connected to said MCP as said optical fiber; and
determining whether, there exist a first attenuation position and a second attenuation position in which said photocurrent shows a predetermined attenuation compared with said peak value within said first predetermined range, at in both directions of said adjustment direction from an interim peak position in which said photocurrent reaches said peak value within said first predetermined range; when there exist said first attenuation position and said second attenuation position, determining said peak position that is an arbitrary position located between said first attenuation position and said second attenuation position, and is located within a second predetermined range from a middle point between said first attenuation position and said second attenuation position.
